(19) United States
(12) Patent Application Publication
(10) Pub. No.: US 2025/0079344 A1
(43) Pub. Date: Mar. 6, 2025

(54) SECURITY CHIP FOR ENSURING THE PHYSICAL INTEGRITY OF AN INTEGRATED CIRCUIT

(71) Applicant: NVIDIA CORPORATION, Santa Clara, CA (US)

(72) Inventors: Elad Mentovich, Tel Aviv (IL); Dongji Xie, Gilroy, CA (US); Ron Chao, San Diego, CA (US)

(73) Assignee: NVIDIA CORPORATION, Santa Clara, CA (US)

(21) Appl. No.: 18/242,316

(22) Filed: Sep. 5, 2023

(51) Int. Cl. H01L 23/00; H01L 23/31; H01L 23/538; H01L 25/065; H01L 25/16

(52) U.S. Cl. CPC H01L 23/576; H01L 23/3107; H01L 23/538; H01L 23/573; H01L 24/16; H01L 24/32; H01L 24/73; H01L 25/0657; H01L 25/162; H01L 2224/16145; H01L 2224/16225; H01L 2224/32145; H01L 2224/32225; H01L 2224/73204; H01L 2225/06513; H01L 2225/06517; H01L 2225/06596; H01L 2924/191

(57) ABSTRACT

A secure electronic component assembly is described herein for ensuring the physical integrity of an integrated circuit (IC). The secure electronic component assembly may comprise a printed circuit board (PCB), an integrated circuit (IC) mounted on the PCB, and a security chip that is operatively coupled to the IC. The IC may comprise a plurality of solder balls operatively coupled thereto and configured for physical and electrical connection between the IC and the PCB. The security chip is configured to detect a potential tampering of the IC.

### TECHNOLOGICAL FIELD

Example embodiments of the present disclosure relate to a security chip and, more particularly, to a security chip for ensuring the physical integrity of an integrated circuit (IC).

### BACKGROUND

With the steady and relentless advancement in technology, the functionality and complexity of Integrated Circuits (ICs) has grown exponentially. As foundational building blocks for most technologies, ICs have become a primary target for malicious tampering activities that aim to alter, steal, or disrupt the functions they control. Tampering with ICs poses severe security risks, such as unauthorized access to sensitive data, interruption of critical services, manipulation of a device's functionality, and/or the like. Given these challenges, there is a pressing need for a security chip that can detect tampering activities in ICs.

Applicant has identified a number of deficiencies and problems associated with current designs for ensuring the physical integrity of an IC. Many of these identified problems have been solved by developing solutions that are included in embodiments of the present disclosure, many examples of which are described in detail herein.

### BRIEF SUMMARY

Systems and methods are provided for a security chip for ensuring the physical integrity of an integrated circuit (IC).

In one aspect, a security chip for ensuring physical integrity of an integrated circuit (IC) is presented. The security chip comprising: a plurality of physical interfaces operatively coupled to the IC; a tamper detection circuit configured to monitor a state of the security chip in response to interactions initiated by the IC, wherein the tamper detection circuit is configured to detect a potential tampering of the IC based on at least the interactions initiated by the IC; and a tamper response circuit configured to execute one or more countermeasures upon a detection of the potential tampering.

In some embodiments, the plurality of physical interfaces is operatively coupled to a plurality of solder balls that are operatively coupled to the IC, wherein the plurality of solder balls is configured for physical and electrical connection between the IC and a printed circuit board (PCB).

In some embodiments, the security chip is embedded in the IC.

In some embodiments, the tamper detection circuit further comprises: one or more sensors configured to detect a change in one or more physical parameters of the IC that is indicative of the potential tampering, wherein the one or more physical parameters comprise at least one of a voltage, current, impedance, light exposure, and onboard temperature.

In some embodiments, the one or more countermeasures comprises at least one of transmitting a signal indicative of the potential tampering to a user input device, disabling one or more functionalities of the security chip, disabling one or more functionalities of the IC, or engaging a physical lock associated with the IC.

In some embodiments, the security chip operates in a passive operation mode.

In some embodiments, the security chip operates in an active operation mode.

In another aspect, a secure electronic component assembly is presented. The assembly comprising: a printed circuit board (PCB); an integrated circuit (IC) mounted on the PCB, wherein the IC comprises a plurality of solder balls operatively coupled thereto and configured for physical and electrical connection between the IC and the PCB; and a security chip operatively coupled to the IC, wherein the security chip is configured to detect a potential tampering of the IC.

In some embodiments, the security chip is operatively coupled to the plurality of solder balls.

In yet another aspect, a method for ensuring physical integrity of an integrated circuit (IC) is presented. The method comprising: monitoring, via a tamper detection circuit, a state of a security chip, wherein the security chip is operatively coupled to the IC; detecting, via the tamper detection circuit, a potential tampering of the IC based on at least a change in the state of the security chip; and executing, via a tamper response circuit, one or more countermeasures upon detection of the potential tampering.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIG. 1 illustrates an example block diagram of a security chip, in accordance with an embodiment of the invention;

FIG. 2A illustrates a secure electronic component assembly in which the security chip is embedded within the integrated circuit (IC), in accordance with an embodiment of the invention;

FIG. 2B illustrates a secure electronic component assembly in which the security chip is externally coupled to the IC, in accordance with an embodiment of the invention;

FIG. 2C illustrates a secure electronic component assembly in which the security chip 100 is externally coupled to the IC, in accordance with an embodiment of the invention; and

FIG. 3 illustrates a method for ensuring the physical integrity of an IC using a security chip, in accordance with an embodiment of the invention.

### DETAILED DESCRIPTION

### Overview

Unauthorized removal and reuse of Integrated Circuits (ICs) from Printed Circuit Boards (PCBs) by unauthorized parties is a pressing problem in the electronics industry. This problem involves the risk of intellectual property theft as these ICs, once removed, can be analyzed and reverse-engineered, resulting in unfair competition and potential loss of profitability for the original manufacturers. Additionally, these components can be utilized to produce counterfeit electronics, which often suffer from poor performance and premature failure and can pose safety issues. This can result in a negative customer experience and can tarnish the reputation of the original manufacturers. Further challenges arise in terms of quality control and data security. The ICs removed might not have undergone the necessary quality checks and could have been damaged during the extraction process, leading to unreliable products. Moreover, these ICs often contain data storage elements, thus posing significant risks of data breaches and potential leaks of sensitive information. From an economic perspective, these issues can cause significant loss for companies that have invested heavily in research, development, and production of their electronics, only to see their components reused without authorization.

The process of mounting an IC onto a PCB typically includes positioning the IC onto the PCB such that the solder balls on the underside of the IC align with the pattern of connection pads on the PCB. Once positioned, heat is applied to melt the solder balls, allowing them to form robust electrical and mechanical connections with the corresponding pads on the PCB. Subsequently, an underfill material is applied in the space between the IC and the PCB. This underfill material may be a specific type of epoxy, selected for its fluidity and curing properties. The underfill material seeps into the gap, encasing the now solidified solder balls and the lower section of the IC. Once cured, the underfill material provides additional support and mechanical strength to the bond between the IC and the PCB. The underfill material also reduces thermal stress of the solder joints, and acts as a protective barrier, safeguarding the IC and the delicate solder joints from environmental factors such as thermal stresses, oxygen, moisture, dust, and corrosive agents. The underfill materials used in this application is typically resistant to any heat or chemicals. An unauthorized person typically removes an IC from the PCB by stripping the underfill material such as by chipping away at the underfill material.

The problems described above may addressed in multiple ways. One such solution, as detailed in an associated patent application incorporated herein by reference at the end of the section, involves the use of an underfill material with a detection agent embedded therein. When an unauthorized user strips the underfill material to remove the IC, the detection agent may be subject to specific stimuli that trigger certain reactions that change the state of the IC from its operational, functional state to a dormant state, non-functional state, restricted functional state, and/or the like. In another solution described herein, a security chip is provided for ensuring the physical integrity of an IC (e.g., graphics processing unit (GPU)). If an unauthorized individual attempts to extract the IC from the PCB, the security chip may be programmed to recognize such tampering and subsequently initiate corrective measures that could result in the IC becoming inoperative. As described in greater detail below with reference to the figures, the security chip may include physical interfaces that are operatively coupled to the IC itself and/or the solder balls on the underside of the IC, a tamper detection circuit that is used to monitor the state of the security chip to detect potential tampering of the IC, and a tamper response circuit that is configured to execute countermeasures upon detection of potential tampering. In some embodiments, the tamper detection circuit may include sensors that are configured to detect a change in the physical parameters of the IC that may be indicative of the potential tampering. These physical parameters may include a voltage, current, impedance, light exposure, and/or onboard temperature. In some other embodiments, the tamper detection circuit may include an active shield layer that may generate an electric field around the embedded security chip, such that any disturbance in the electric field may be indicative of potential tampering with the IC. When potential tampering is detected, the tamper response circuit may execute countermeasures, such as by transmitting signal indicative of the potential tampering to a user input device, disabling one or more functionalities of the security chip, disabling one or more functionalities of the IC, engaging a physical lock associated with the IC, and/or the like. In this way, embodiments of the invention implement hardware-level security measures to ensure that the IC is tamper-proof.

While the invention has been described with reference to specific embodiments thereof, it will, however, be evident that various modifications and changes may be made thereto without departing from the broader spirit and scope of the invention. Specifically, while the invention has been described in the context of a singular security chip, one skilled in the art will recognize that the invention may be utilized with multiple security chips, either in coordination or in parallel, as suitable or necessary for a given application. Therefore, the specification and drawings are, accordingly, to be regarded in an illustrative rather than a restrictive sense.

### Example Security Chip

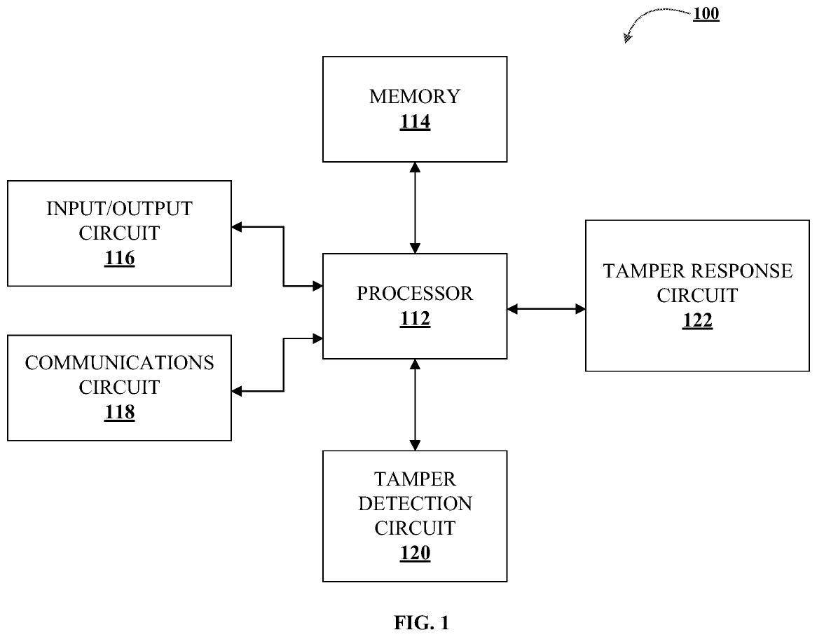

FIG. 1 illustrates an example block diagram of a security chip 100, in accordance with an embodiment of the invention. As shown in FIG. 1, the security chip 100 may include a processor 112, a memory 114, an input/output circuit 116, a communications circuit 118, a tamper detection circuit 120, and a tamper response circuit 122.

Although the term “circuit” as used herein with respect to components 112-122 is described in some cases using functional language, it should be understood that the particular implementations necessarily include the use of particular hardware configured to perform the functions associated with the respective circuit as described herein. It should also be understood that certain of these components 112-122 may include similar or common hardware. For example, two sets of circuitries may both leverage the same processor, network interface, storage medium, or the like to perform their associated functions, such that duplicate hardware is not required for each set of circuitries.

While the term “circuit” should be understood broadly to include hardware, in some embodiments, the term “circuit” may also include software for configuring the hardware. For example, in some embodiments, “circuit” may include processing circuitry, storage media, network interfaces, input/output devices, and the like. In some embodiments, other elements of the security chip 100 may provide or supplement the functionality of a particular circuit. For example, the processor 112 may provide processing functionality, the memory 114 may provide storage functionality, the communications circuit 118 may provide network interface functionality, and the like.

In some embodiments, the processor 112 (and/or co-processor or any other processing circuit assisting or otherwise associated with the processor) may be in communication with the memory 114 via a bus for passing information among components of, for example, the security chip 100. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the security chip 100, to carry out various functions in accordance with example embodiments of the present disclosure.

Although illustrated in FIG. 1B as a single memory, the memory 114 may comprise a plurality of memory components. The plurality of memory components may be embodied on a single computing device or distributed across a plurality of computing devices. In various embodiments, the memory 114 may comprise, for example, a flash memory, a static random access memory (SRAM), a dynamic random access memory (DRAM), an electrically erasable programmable read-only memory (EEPROM), a read only memory (ROM), a non-volatile random access memory (NVRAM), or some combination thereof. The memory 114 may be configured to store information, data, applications, instructions, such as firmware, operational parameters, tamper detection thresholds, data logs, or the like, for enabling the security chip 100 to carry out various functions in accordance with example embodiments discussed herein. For example, in at least some embodiments, the memory 114 is configured to buffer data for processing by the processor 112. Additionally, or alternatively, in at least some embodiments, the memory 114 is configured to store program instructions for execution by the processor 112. The memory 114 may store information in the form of static and/or dynamic information. This stored information may be stored and/or used by the security chip 100 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuit, one or more computers, various other processing elements including integrated circuits such as, for example, an ASIC (application specific integrated circuit) or FPGA (field programmable gate array), or some combination thereof. The use of the term “processing circuit” may be understood to include a single core processor, a multi-core processor, multiple processors internal to the apparatus, and/or remote or “cloud” processors. Accordingly, although illustrated in FIG. 1 as a single processor, in some embodiments, the processor 112 may include a plurality of processors. The plurality of processors may be embodied on a single computing device or may be distributed across a plurality of such devices collectively configured to function as the security chip 100. The plurality of processors may be in operative communication with each other and may be collectively configured to perform one or more functionalities of the security chip 100 as described herein.

In an example embodiment, the processor 112 is configured to execute instructions stored in the memory 114 or otherwise accessible to the processor 112. Alternatively or additionally, the processor 112 may be configured to execute hard-coded functionality. As such, whether configured by hardware or software methods, or by a combination thereof, the processor 112 may represent an entity (e.g., physically embodied in circuit) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the security chip 100 to perform one or more of the functionalities thereof as described herein.

In some embodiments, the security chip 100 further includes an input/output circuit 116 that may, in turn, be in communication with the processor 112 to provide an audible, visual, mechanical, or other output and/or, in some embodiments, to receive an indication of an input from a user or another source. In that sense, the input/output circuit 116 may include means for performing analog-to-digital and/or digital-to-analog data conversions. The input/output circuit 116 may include support, for example, for digital input/output pins, analog input/output pins, serial interfaces such as universal asynchronous receiver/transmitter (UART), inter-integrated circuit (I2C), serial peripheral interface (SPI), and/or the like, general purpose input/output pins, and/or other input/output mechanisms. The input/output circuit 116 may include a user interface and may include a web interface, a mobile application, or the like.

The processor 112 may be configured to control one or more functions of a display, alert, notification, and/or the like, or one or more interface elements through computer-program instructions (e.g., software and/or firmware) stored on a memory accessible to the processor 112 (e.g., the memory 114, and/or the like). In some embodiments, aspects of the input/output circuit 116 may be reduced as compared to embodiments where the security chip 100 may be implemented as an end-user chip or other type of device designed for complex customer interactions. In some embodiments (and as may be the case with other components discussed herein), the input/output circuit 116 may be eliminated from the security chip 100. The input/output circuit 116 may be in communication with the memory 114, the communications circuit 118, and/or any other component(s), such as via a bus. Although more than one input/output circuit and/or other component can be included in the security chip 100, only one is shown in FIG. 1 to avoid overcomplicating the disclosure for ease of explanation (e.g., as with the other components discussed herein).

The communications circuit 118, in some embodiments, includes any means, such as a device or circuit embodied in either hardware, software, firmware or a combination of hardware, software, and/or firmware, that is configured to receive and/or transmit data from/to a network and/or any other device, circuit, or module in communication with the device. In this regard, the communications circuit 118 may include, for example, a network interface for enabling communications with a wired or wireless communication network. For example, in some embodiments, communications circuit 118 may be configured to receive and/or transmit data that may be stored by the memory 114 using any protocol that may be used for communications between computing devices. For example, the communications circuit 118 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuit 118 may include circuitry for interacting with antenna (e) to cause transmission of signals via the antenna (e) or to handle receipt of signals received via the antenna (e). These signals may be transmitted by the security chip 100 using any of a number of wireless personal area network (PAN) technologies, such as Bluetooth® v 1.0 through v 5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuit 118 may additionally or alternatively be in communication with the memory 114, the input/output circuit 116, and/or any other component of the security chip 100, such as via a bus. The communication circuit 118 of the security chip 100 may also be configured to receive and transmit information with the various network ports discussed herein.

The tamper detection circuit 120 may include hardware, software, firmware, and/or a combination of such components, for surveillance and anomaly detection, aimed at identifying potential tampering activities that could compromise the IC. To this end, the tamper detection circuit 120 may be configured to monitor the state of the IC in real-time, primarily through interactions initiated by the IC. In example embodiments, the tamper detection circuit 120 may include one or more sensors that are designed to detect changes in one or more physical parameters of the IC that could indicate potential tampering. In various embodiments, physical parameters may include voltage, current, and impedance, light exposure, onboard temperature, and/or the like. In one aspect, voltage, current, and impedance measurements that may provide insight into the electrical functioning of the IC and can help identify unusual electrical behaviors indicative of tampering. For instance, unexpected changes in the voltage levels or current flow may suggest an unauthorized attempt to bypass or manipulate the IC's operations. In another aspect, any abrupt or unusual detection of light exposure could be indicative of a direct, physical attempt to access or alter the IC, such as the removal of the IC from its enclosure or the decapsulation of the IC package. In yet another aspect, any sudden increase or decrease in onboard temperature may signify attempts to exploit the IC's vulnerabilities through temperature variations.

Upon detection of such changes, the tamper detection circuit 120 may trigger the tamper response circuit 122. The tamper response circuit 122 may include hardware, software, firmware, and/or a combination of such components, for executing one or more predefined countermeasures to mitigate the effects of the tampering and safeguard the integrity of the IC. In some embodiments, the tamper response circuit 122 may be configured to execute various countermeasures based on the nature and severity of the detected threat. In one aspect, the countermeasure may include alert generation. Upon detecting potential tampering, the tamper response circuit 122 may generate an alert signal to trigger an onboard alarm, or to be transmitted to an external device such as a control console. In another aspect, for more severe threats, the countermeasure may include a system lockdown, whereby the tamper response circuit 122 may disable some, or all functionalities of the IC and/or the security chip 100 to prevent further IC compromise until additional measures can be taken. In yet another aspect, in ICs that store sensitive data, the countermeasure may include encrypting or erasing onboard data upon detection of potential tampering to prevent unauthorized access to the data. In still other aspects, the countermeasure may include activation of a physical lock or altering the physical state of the IC to hinder the tampering attempt. In example embodiments, the physical lock may be a micro-mechanical device integrated within the IC or its housing. When triggered, the physical lock can mechanically lock or block specific parts of the IC, making further intrusion attempts considerably more challenging. The physical lock may be configured to either obstruct access to certain critical regions of the IC or securely seal the entire IC, thus preventing any physical access without causing overt damage.

In some embodiments, the security chip 100 includes hardware, software, firmware, and/or a combination of such components, configured to support various aspects of tamper detection and response execution. It should be appreciated that in some embodiments, the tamper detection circuit 120 and/or the tamper response circuit 122 may perform one or more of such example actions in combination with other circuitry of the security chip 100, such as the memory 114, the processor 112, the input/output circuit 116, and/or the communications circuit 118. For example, in some embodiments, the tamper detection circuit 120 and/or the tamper response circuit 122 utilizes processing circuitry, such as the processor 112 and/or the like, to form a self-contained subsystem to perform one or more of its corresponding operations. In a further example, and in some embodiments, some or all of the functionality of the tamper detection circuit 120 and/or the tamper response circuit 122 may be performed by the processor 112. Accordingly, in some embodiments, the processor 112 may comprise the tamper detection circuit 120 and/or the tamper response circuit 122. In this regard, some or all of the example processes and algorithms discussed herein can be performed by at least one of the processor 112, the tamper detection circuit 120, and/or the tamper response circuit 122. It should also be appreciated that, in some embodiments, the tamper detection circuit 120 and/or the tamper response circuit 122 may include a separate processor, specially configured field programmable gate array (FPGA), or application specific interface circuit (ASIC) to perform its corresponding functions.

### Example Secure Electronic Component Assembly

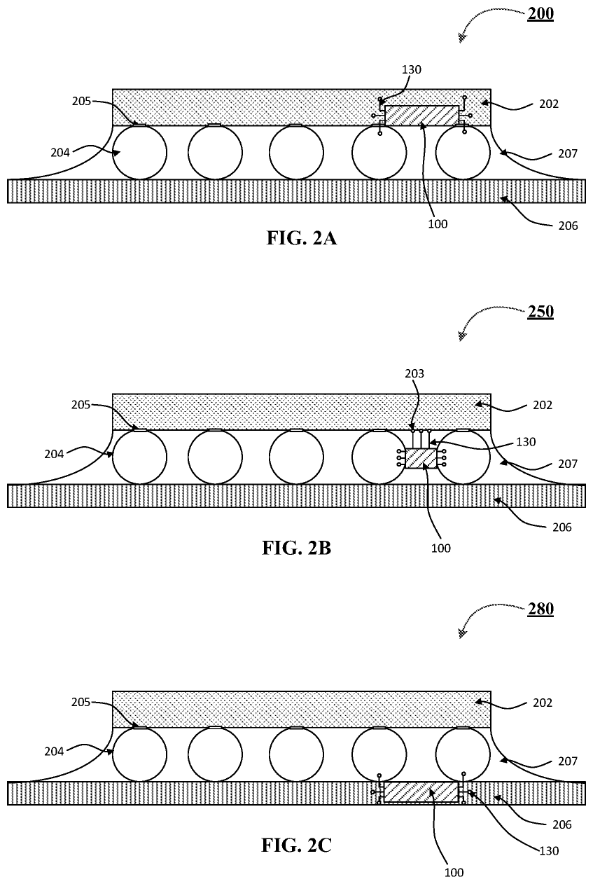

FIG. 2A illustrates a secure electronic component assembly 200 in which the security chip 100 is embedded within the integrated circuit (IC), in accordance with an embodiment of the invention. As shown in FIG. 2A, the secure electronic component assembly 200 may include a printed circuit board (PCB) 206, an IC 202 mounted on the PCB 206, and a security chip 100 embedded within the IC 202 and configured to detect and subsequently respond to potential tampering events. The IC 202 may be mounted on the PCB 206 to establish both physical and electrical connections therewith through a plurality of solder balls 204. The solder balls 204 may serve as a primary point of contact between the IC 202 and the PCB 206. The solder balls 204 may be arranged in a grid-like pattern and strategically positioned on the underside of the IC 202. The solder balls 204 may be made from a lead-tin alloy or a lead-free alternative, chosen for its favorable properties such as high electrical conductivity and melting point suitable for establishing a strong, reliable, and conductive connection. In example embodiments, the solder balls 204 may be placed onto specific points, often referred to as solder pads 205, on the bottom side of the IC 202 in a uniform and predetermined pattern, typically corresponding to the layout of contact points on the PCB 206, ensuring accurate alignment and connection. When the IC 202 is placed onto the PCB 206, the solder balls 204 align with corresponding contact points on the PCB 206. Once aligned, the IC 202 and the PCB 206 are subject to a soldering process (e.g., reflow process) in which the solder balls 204 are heated to a temperature that exceeds the melting point of the solder material, causing the solder balls 204 to melt, and upon cooling, subsequently solidify to form robust mechanical and electrical connections between the IC 202 and the PCB 206. In some embodiments, upon mounting the IC 202 onto the PCB 206, an underfill material 207 may be applied in the space between the IC 202 and the PCB 206 to distribute thermal and mechanical stresses across the IC 202 and the PCB 206, adding an extra layer of adhesion and protection between the IC 202 and the PCB 206.

As shown in FIG. 2A, in some embodiments, the security chip 100 may be integrated with the IC 202 during the fabrication process at a silicon level where the security chip 100 and the IC 202 are fabricated as a single unit, albeit with distinct functionalities. The security chip may include a plurality of physical interfaces 130 that may be used to operatively couple the security chip to the IC 202. In some embodiments, the physical interfaces 130 may be tangible points of contact or connection which enable the chip to communicate with, monitor, and influence the IC's 202 functioning. For example, the physical interfaces 130 may constantly relay real-time temperature readings from the IC 202 to the security chip 100. In turn, the security chip 100, upon detecting anomalies or values outside of a designated threshold, can send corrective instructions through the physical interfaces 130 to adjust the IC's 202 operations, thereby maintaining desired temperature levels. In example embodiments, the physical interfaces 130 may be configured in the form of pins, pads, connectors, wire bonds, and/or the like. When integrated with the IC 202, during the fabrication process, the physical interfaces 130 of the security chip 100 may be positioned to directly connect with the solder balls 204 or the solder pads 205 on which the solder balls 204 are situated. In alternative embodiments, when integrated with the IC 202, the security chip 100 may be positioned under the die shadow area where no solder pads 205 or solder balls 204 are located. In one aspect, the physical interfaces 130 may be fabricated on the same layer as the solder balls 204, ensuring direct connectivity. In another aspect, the physical interfaces may be placed on a different layer, with vias-small conductive holes that connect different layers of the IC-ensuring the electrical connection. In embodiments where the physical interfaces 130 of the security chip 100 are connected with the solder pads 205, the physical interfaces 130 would essentially be connected to the solder balls 204 as well. This is because, once the IC 202 is heated during the soldering process, the solder balls 204 would melt and fuse with the solder pads 205, creating a solid, conductive connection that also includes the physical interfaces 130 of the security chip 100. In some embodiments, upon mounting the IC 202 (with the security chip 100 embedded thereon) onto the PCB 206, an underfill material 207 may be applied in the space between the IC 202 and the PCB 206 in such a way that the underfill material 207 encapsulates all conductive connections between the security chip 100, the IC 202, and/or the solder balls 204.

FIG. 2B illustrates a secure electronic component assembly 250 in which the security chip 100 is embedded within the PCB 206, in accordance with an embodiment of the invention. As shown in FIG. 2B, in some embodiments, the security chip may be externally connected to the IC to form a secure electronic component assembly 250. In this configuration, the security chip 100 may not be integrally formed as part of the IC's 202 fabrication process but may instead be externally coupled with the IC 202 after the IC's 202 fabrication. In one aspect, the security chip 100 may be positioned in the die shadow area under the IC 202 in such a way that the physical interfaces 130 of the security chip are aligned with corresponding points of contact 203 on the IC 202 and/or the corresponding soldering balls 204 of the IC 202. Once aligned, the security chip 100 may be externally coupled with the IC 202 using the physical interfaces 130 of the security chip 100 and additional conductive elements such as wire bonds, flip-chip bumps, and/or the like to establish a conductive connection between the security chip 100 and the IC 202. In some embodiments, upon externally coupling the security chip 100 to the IC 202, an underfill material 207 may be applied in the space between the IC 202 and the PCB 206 encapsulating the security chip 100, and securing the security chip 100 from being moved or dismantled without damage.

FIG. 2C illustrates a secure electronic component assembly 280 in which the security chip 100 is externally coupled to the IC 250, in accordance with an embodiment of the invention. As shown in FIG. 2C, in some embodiments, the security chip 100 may be integrated with the PCB 206 during the fabrication process at a silicon level where the security chip 100 and the PCB 206 are fabricated as a single unit, albeit with distinct functionalities. The security chip may include a plurality of physical interfaces 130 that may be used to operatively couple the security chip to the IC 202. When integrated with the PCB 206, during the fabrication process, the physical interfaces 130 of the security chip 100 may be positioned to directly connect with the solder balls 204. In alternative embodiments, when integrated with the IC 202, the security chip 100 may be positioned under the die shadow area where no solder pads 205 or solder balls 204 are located. In some embodiments, upon mounting the IC 202 (with the security chip 100 embedded thereon) onto the PCB 206, an underfill material 207 may be applied in the space between the IC 202 and the PCB 206 in such a way that the underfill material 207 encapsulates all conductive connections between the security chip 100, the PCB 206, and/or the solder balls 204.

In some embodiments, the security chip 100 may be a passive chip or operate in a passive operation mode. In such cases, the security chip 100 may primarily operate in a dormant or low-energy mode, primarily focusing on conserving energy and resources. Despite its subdued activity, the security chip 100 may continuously monitor for specific triggers or criteria which, when met, can transition from its passive operational mode to an active operational mode. For example, while the high-frequency processing tasks are minimized, the security chip 100 may still be attuned to detect particular signals or anomalies, ensuring that the chip can transition to an active operational mode when required, especially during crucial security-related events. In its passive operational mode, the security chip 100 may also be engaged in safeguarding stored data, ensuring data integrity and encryption standards remain uncompromised. In some embodiments, the security chip 100 may have scheduled communication intervals during which the security chip 100 briefly transitions from its passive state at predetermined times to communicate or relay data, before reverting back to its energy-conserving mode. In further embodiments, the security chip 100, in its passive state can also employ a buffer system where incoming data or alerts may be temporarily stored and then processed either at scheduled intervals or when the chip transitions back to its active operational mode.

In some other embodiments, the security chip 100 may be an active chip or operate in an active operation mode. In such cases, the security chip 100 may be configured to provide real-time responses, high-frequency processing, and robust security measures. In an active operational mode, the security chip 100 is fully engaged, consuming more power to cater to the demands of continuous surveillance, data processing, and instantaneous communication. In contrast to the passive operation during which the security chip 100 communicates at scheduled intervals, during active operation, the security chip 100 is in constant communication with associated systems or components, with the capacity to instantly relay alerts, receive updates, or coordinate with other chips or systems for synchronized operations.

### Example Methods for Ensuring the Physical Integrity of an IC Using a Security Chip

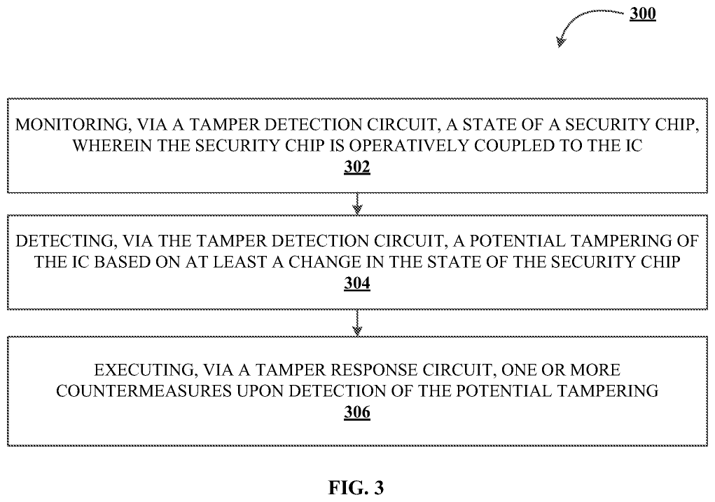

FIG. 3 illustrates a method 300 for ensuring the physical integrity of an IC using a security chip, in accordance with an embodiment of the invention. As shown in block 302, the method may include monitoring, via a tamper detection circuit, a state of a security chip, wherein the security chip is operatively coupled to the IC. As described herein, an unauthorized person may remove an IC from the PCB by stripping the underfill material, such as by chipping away at the underfill material or dissolving the underfill material altogether using an appropriate solvent. Any of these actions, if successful, could potentially affect the state of the security chip encapsulated in the underfill material. In some embodiments, the state of the security chip may refer to various characteristics, including its operational mode, its electrical characteristics, its thermal state, and the status of its various subsystems, such as the security chip's voltage level, current flow, power consumption, temperature, light exposure, and/or any other quantifiable aspects that can be monitored. In some embodiments, the state of the security chip may also refer to a software status of the security chip, including the status of certain processes or the presence of certain signals. In some embodiments, the tamper detection circuit may include an active shield layer that may generate an electric field around the security chip, such that any disturbance in the electric field may be indicative of potential tampering with the IC. In example embodiments, the tamper detection circuit may include a plurality of sensors and emitters embedded within or around the shield layer that may be calibrated to produce an electric field of a specific intensity and pattern. Any external interaction or intrusion, such as an attempt to probe, access, or otherwise tamper with the security chip may lead to a disruption in the established electric field. The change could be a variation in the field's intensity, a shift in its pattern, or any other anomaly inconsistent with its regular state.

As shown in block 304, the method may include detecting, via the tamper detection circuit, a potential tampering of the IC based on at least a change in the state of the security chip. As described herein, the tamper detection circuit may be designed to recognize normal states and to flag any deviations from the norm. Monitoring the state of the security chip allows for real-time detection of any unusual events or potential security threats to the IC. If the tamper detection circuit identifies a parameter that falls outside of a predetermined range, it can interpret this as a sign of potential tampering.

Under normal circumstances, the characteristics that define the state of the security chip may follow predictable patterns or remain within a predefined range. However, if the IC were to be tampered with, it would likely cause some alterations to these characteristics. For instance, if an unauthorized person tries to physically remove or alter the IC, it may cause changes in the electrical connections, which in turn would affect the voltage levels or current flow in the security chip. Similarly, using a solvent to dissolve the underfill material could potentially increase the temperature around the security chip, a change that could be detected by the circuit. According to embodiments of the invention, when the tamper detection circuit registers a change in the state of the security chip that falls outside the normal parameters, it interprets this change as indicative of a potential tampering event.

As shown in block 306, the method may include executing, via a tamper response circuit, one or more countermeasures upon detection of the potential tampering. In some embodiments, upon identifying a possible tampering attempt, as indicated by changes in the state of the security chip, the tamper detection circuit may transmit a signal to the tamper response circuit to execute one or more countermeasures specifically designed to respond to the tampering attempt. As described herein, the countermeasures may include alert generation, functional shutdown of the security chip, the IC, and/or the PCB, data protection measures, physical countermeasures, chip reset, and/or the like.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | U.S. Patent | | |
|---|---|---|---|
| Docket Number | Application Ser. No. | Title | Filed On |
| 048833.000151 | To be assigned | SECURE ELECTRONIC | Filed Concurrently |
| | | COMPONENT ASSEMBLY | Herewith |

What is claimed is:

1. A security chip for ensuring physical integrity of an integrated circuit (IC), the security chip comprising:
a plurality of physical interfaces operatively coupled to the IC;
a tamper detection circuit configured to monitor a state of the security chip in response to interactions initiated by the IC, wherein the tamper detection circuit is configured to detect a potential tampering of the IC based on at least the interactions initiated by the IC; and
a tamper response circuit configured to execute one or more countermeasures upon a detection of the potential tampering.

2. The security chip of claim 1, wherein the plurality of physical interfaces is operatively coupled to a plurality of solder balls that are operatively coupled to the IC, wherein the plurality of solder balls is configured for physical and electrical connection between the IC and a printed circuit board (PCB).

3. The security chip of claim 1, wherein the security chip is embedded in the IC.

4. The security chip of claim 1, wherein the tamper detection circuit further comprises:
one or more sensors configured to detect a change in one or more physical parameters of the IC that is indicative of the potential tampering, wherein the one or more physical parameters comprise at least one of a voltage, current, impedance, light exposure, and onboard temperature.

5. The security chip of claim 1, wherein the one or more countermeasures comprises at least one of transmitting a signal indicative of the potential tampering to a user input device, disabling one or more functionalities of the security chip, disabling one or more functionalities of the IC, or engaging a physical lock associated with the IC.

6. The security chip of claim 1, wherein the security chip operates in a passive operation mode.

7. The security chip of claim 1, wherein the security chip operates in an active operation mode.

8. A secure electronic component assembly, comprising:
a printed circuit board (PCB);
an integrated circuit (IC) mounted on the PCB, wherein the IC comprises a plurality of solder balls operatively coupled thereto and configured for physical and electrical connection between the IC and the PCB; and
a security chip operatively coupled to the IC, wherein the security chip is configured to detect a potential tampering of the IC.

9. The assembly of claim 8, wherein the security chip is operatively coupled to the plurality of solder balls.

10. The assembly of claim 8, wherein the security chip is embedded in the IC.

11. The assembly of claim 8, wherein the security chip further comprises:
a plurality of physical interfaces operatively coupled to the IC;
a tamper detection circuit configured to monitor a state of the security chip in response to interactions initiated by the IC, wherein the tamper detection circuit is configured to detect a potential tampering of the IC based on at least the interactions initiated by the IC; and
a tamper response circuit configured to execute one or more countermeasures upon a detection of the potential tampering.

12. The assembly of claim 11, wherein the tamper detection circuit further comprises:
one or more sensors configured to detect a change in one or more physical parameters of the IC that is indicative of the potential tampering, wherein the one or more physical parameters comprise at least one of a voltage, current, impedance, light exposure, and onboard temperature.

13. The assembly of claim 11, wherein the one or more countermeasures comprises at least one of transmitting a signal indicative of the potential tampering to a user input device, disabling one or more functionalities of the security chip, disabling one or more functionalities of the IC, or engaging a physical lock associated with the IC.

14. A method for ensuring physical integrity of an integrated circuit (IC), the method comprising:
monitoring, via a tamper detection circuit, a state of a security chip, wherein the security chip is operatively coupled to the IC;
detecting, via the tamper detection circuit, a potential tampering of the IC based on at least a change in the state of the security chip; and
executing, via a tamper response circuit, one or more countermeasures upon detection of the potential tampering.

15. The method of claim 14, wherein the tamper detection circuit further comprises:
one or more sensors configured to detect a change in one or more physical parameters of the IC, wherein the change in the one or more physical parameters causes the change in the state of the security chip that is indicative of the potential tampering, wherein the one or more physical parameters comprise at least one of a voltage, current, impedance, light exposure, and onboard temperature.

16. The method of claim 14, wherein the one or more countermeasures comprises at least one of transmitting a signal indicative of the potential tampering to a user input device, disabling one or more functionalities of the security chip, disabling one or more functionalities of the IC, or engaging a physical lock associated with the IC.

17. The method of claim 14, wherein the security chip is operatively coupled to a plurality of solder balls that are operatively coupled to the IC, wherein the plurality of solder balls is configured for physical and electrical connection between the IC and a printed circuit board (PCB).

18. The method of claim 14, wherein the security chip operates in a passive operation mode.

19. The method of claim 14, wherein the security chip operates in an active operation mode.
